(19) United States
(12) Patent Application Publication
(10) Pub. No.: US 2026/0045975 A1
(43) Pub. Date: Feb. 12, 2026

(54) INTERFERER BEAM REFINEMENT FOR MU-MIMO COMMUNICATIONS

(71) Applicant: QUALCOMM Incorporated, San Diego, CA (US)

(72) Inventors: Meilong JIANG, Westfield, NJ (US); Jing SUN, San Diego, CA (US); Yu ZHANG, San Diego, CA (US); Jing JIANG, San Diego, CA (US)

(21) Appl. No.: 18/797,359

(22) Filed: Aug. 7, 2024

(51) Int. Cl. H04B 7/0452; H04B 7/0456; H04B 7/06

(52) U.S. Cl. CPC H04B 7/0452; H04B 7/0456; H04B 7/0626; H04B 7/0632

(57) ABSTRACT

Methods, systems, and devices for wireless communications are described. The network entity and a set of UEs may be enabled to refine precoders utilized in communications with each UE. For example, a first UE may utilize reference signaling from a network entity to generate precoding matrix information (PMI) and may transmit the PMI to the network entity, which may forward the PMI to a second UE. The network entity may also forward PMI of the second UE to the first UE. The first UE may utilize the PMI of the second UE, as well as feedback associated with the first UE, to refine the PMI of the second UE, and the second UE may do the same for the first UE. The UEs may transmit the modified PMIs to the network entity, and the network entity may communicate with each of the UEs according to the modified PMIs.

### FIELD OF TECHNOLOGY

The following relates to wireless communications, including interferer beam refinement for multi-user, multiple-input multiple-output (MU-MIMO) communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some examples of wireless communications, one or more devices may operate in accordance with multi-user multiple-input multiple-output (MU-MIMO) communications. For example, a network entity may concurrently transmit multiple data streams to a set of spatially multiplexed (SPMed) user equipments (UEs). In some examples, MU-MIMO communications may be based on one or more UEs updating a precoding matrix at the network entity using information of a channel from each network entity transmission antenna to each respective UE reception antenna. The UE and the network entity may communicate utilizing this updated precoding matrix.

### SUMMARY

The systems, methods, and devices of this disclosure each have several innovative aspects, no single one of which is solely responsible for the desirable attributes disclosed herein.

A method for wireless communications by a first user equipment (UE) is described. The method may include receiving, from a network entity, first precoding matrix information for a beam associated with a second UE for a multiple-user multiple-input multiple-output (MU-MIMO) configuration, transmitting, to the network entity, second precoding matrix information for an updated beam associated with the second UE, where the second precoding matrix information is based on measured channel information and a predicted interference level of the beam associated with the second UE and associated with the MU-MIMO configuration and the first precoding matrix information, and communicating with the network entity according to the MU-MIMO configuration based on transmitting the second precoding matrix information for the updated beam associated with the second UE.

A first UE for wireless communications is described. The first UE may include one or more memories storing processor executable code, and one or more processors coupled with the one or more memories. The one or more processors may individually or collectively be operable to execute the code to cause the first UE to receive, from a network entity, first precoding matrix information for a beam associated with a second UE for a MU-MIMO configuration, transmit, to the network entity, second precoding matrix information for an updated beam associated with the second UE, where the second precoding matrix information is based on measured channel information and a predicted interference level of the beam associated with the second UE and associated with the MU-MIMO configuration and the first precoding matrix information, and communicate with the network entity according to the MU-MIMO configuration based on transmitting the second precoding matrix information for the updated beam associated with the second UE.

Another first UE for wireless communications is described. The first UE may include means for receiving, from a network entity, first precoding matrix information for a beam associated with a second UE for a MU-MIMO configuration, means for transmitting, to the network entity, second precoding matrix information for an updated beam associated with the second UE, where the second precoding matrix information is based on measured channel information and a predicted interference level of the beam associated with the second UE and associated with the MU-MIMO configuration and the first precoding matrix information, and means for communicating with the network entity according to the MU-MIMO configuration based on transmitting the second precoding matrix information for the updated beam associated with the second UE.

A non-transitory computer-readable medium storing code for wireless communications is described. The code may include instructions executable by one or more processors to receive, from a network entity, first precoding matrix information for a beam associated with a second UE for a MU-MIMO configuration, transmit, to the network entity, second precoding matrix information for an updated beam associated with the second UE, where the second precoding matrix information is based on measured channel information and a predicted interference level of the beam associated with the second UE and associated with the MU-MIMO configuration and the first precoding matrix information, and communicate with the network entity according to the MU-MIMO configuration based on transmitting the second precoding matrix information for the updated beam associated with the second UE.

Some examples of the method, first user equipment (UEs), and non-transitory computer-readable medium described herein may further include operations, features, means, or instructions for transmitting, to the network entity, third precoding matrix information for a beam associated with the first UE for the MU-MIMO configuration, where the third precoding matrix information may be based on the measured channel information associated with the MU-MIMO configuration and receiving, from the network entity, fourth precoding matrix information for an updated beam associated with the first UE, where the fourth precoding matrix information may be based on second channel information associated with the MU-MIMO configuration and the third precoding matrix information.

In some examples of the method, first UEs, and non-transitory computer-readable medium described herein, receiving the fourth precoding matrix information for the updated beam associated with the first UE may include operations, features, means, or instructions for receiving, from the network entity, one or more demodulated reference signals (DMRSs) including the fourth precoding matrix information.

Some examples of the method, first UEs, and non-transitory computer-readable medium described herein may further include operations, features, means, or instructions for selecting a codebook for the second UE according to the measured channel information and the predicted interference level of the beam associated with the second UE and associated with the MU-MIMO configuration and the first precoding matrix information, where transmitting the second precoding matrix information for the beam associated with the second UE may be based on selecting the codebook.

Some examples of the method, first UEs, and non-transitory computer-readable medium described herein may further include operations, features, means, or instructions for determining one or more interference factors associated with the beam associated with the second UE and adjusting the first precoding matrix information based on the one or more interference factors, where the second precoding matrix information corresponds to the adjusted first precoding matrix information.

Some examples of the method, first UEs, and non-transitory computer-readable medium described herein may further include operations, features, means, or instructions for receiving, from the network entity, one or more channel state information reference signals (CSI-RS), where the second precoding matrix information may be based on measurements of the one or more CSI-RS.

Some examples of the method, first UEs, and non-transitory computer-readable medium described herein may further include operations, features, means, or instructions for receiving, from the network entity based on transmitting the second precoding matrix information, fifth precoding matrix information for the beam associated with the second UE for the MU-MIMO configuration and transmitting, to the network entity, sixth precoding matrix information for the beam associated with the second UE, where the sixth precoding matrix information may be based on the measured channel information associated with the MU-MIMO configuration and the fifth precoding matrix information.

Some examples of the method, first UEs, and non-transitory computer-readable medium described herein may further include operations, features, means, or instructions for receiving, from the network entity, one or more channel quality indicators (CQIs) associated with the second UE for the MU-MIMO configuration, where transmitting the second precoding matrix information may be based on receiving the one or more CQIs.

Some examples of the method, first UEs, and non-transitory computer-readable medium described herein may further include operations, features, means, or instructions for receiving, from the network entity, rank information associated with the second UE for the MU-MIMO configuration, where transmitting the second precoding matrix information may be based on the rank information.

Some examples of the method, first UEs, and non-transitory computer-readable medium described herein may further include operations, features, means, or instructions for transmitting, to the network entity, one or more CQIs and an interference level associated with the first UE for the MU-MIMO configuration.

In some examples of the method, first UEs, and non-transitory computer-readable medium described herein, communicating with the network entity according to the MU-MIMO configuration may include operations, features, means, or instructions for receiving, from the network entity, a layer of a MU-MIMO transmission including downlink data.

A method for wireless communications by a network entity is described. The method may include outputting, to a first UE, first precoding matrix information for a beam associated with a second UE for a MU-MIMO configuration, obtaining, from the first UE, second precoding matrix information for the beam associated with the second UE, and communicating with the first UE and the second UE according to the MU-MIMO configuration based on receiving the second precoding matrix information for the beam associated with the second UE.

A network entity for wireless communications is described. The network entity may include one or more memories storing processor executable code, and one or more processors coupled with the one or more memories. The one or more processors may individually or collectively be operable to execute the code to cause the network entity to output, to a first UE, first precoding matrix information for a beam associated with a second UE for a MU-MIMO configuration, obtain, from the first UE, second precoding matrix information for the beam associated with the second UE, and communicate with the first UE and the second UE according to the MU-MIMO configuration based on receiving the second precoding matrix information for the beam associated with the second UE.

Another network entity for wireless communications is described. The network entity may include means for outputting, to a first UE, first precoding matrix information for a beam associated with a second UE for a MU-MIMO configuration, means for obtaining, from the first UE, second precoding matrix information for the beam associated with the second UE, and means for communicating with the first UE and the second UE according to the MU-MIMO configuration based on receiving the second precoding matrix information for the beam associated with the second UE.

A non-transitory computer-readable medium storing code for wireless communications is described. The code may include instructions executable by one or more processors to output, to a first UE, first precoding matrix information for a beam associated with a second UE for a MU-MIMO configuration, obtain, from the first UE, second precoding matrix information for the beam associated with the second UE, and communicate with the first UE and the second UE according to the MU-MIMO configuration based on receiving the second precoding matrix information for the beam associated with the second UE.

Some examples of the method, network entities, and non-transitory computer-readable medium described herein may further include operations, features, means, or instructions for determining third precoding matrix information for the beam associated with the second UE based on receiving the second precoding matrix information, where communicating with the first UE according to the MU-MIMO configuration may be based on the third precoding matrix information.

Some examples of the method, network entities, and non-transitory computer-readable medium described herein may further include operations, features, means, or instructions for outputting, to the second UE, third precoding matrix information for a second beam associated with the first UE, where the third precoding matrix information may be based on channel information associated with the MU-MIMO configuration measured by the first UE, obtaining, from the second UE, fourth precoding matrix information for the second beam associated with the first UE, and outputting, to the first UE, fifth precoding matrix information for the second beam associated with the first UE, where the fourth precoding matrix information may be based on the fourth precoding matrix information.

In some examples of the method, network entities, and non-transitory computer-readable medium described herein, outputting the fifth precoding matrix information for the second beam associated with the first UE may include operations, features, means, or instructions for outputting, to the first UE, one or more DMRSs including the fifth precoding matrix information.

Some examples of the method, network entities, and non-transitory computer-readable medium described herein may further include operations, features, means, or instructions for outputting, to the first UE, one or more CQIs associated with the second UE for the MU-MIMO configuration, where outputting the second precoding matrix information may be based on obtaining the one or more CQIs.

Some examples of the method, network entities, and non-transitory computer-readable medium described herein may further include operations, features, means, or instructions for outputting, to the first UE, one or more CSI-RS, where the one or more CSI-RS may be determined based on the first precoding information.

In some examples of the method, network entities, and non-transitory computer-readable medium described herein, communicating with the first UE according to the MU-MIMO configuration may include operations, features, means, or instructions for outputting, to the first UE, a first layer of a MU-MIMO transmission including first downlink data and outputting, to the second UE concurrently with outputting the first layer, a second layer of the MU-MIMO transmission including second downlink data.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show examples of wireless communications systems that support interferer beam refinement for multi-user, multiple-input multiple-output (MU-MIMO) communications in accordance with one or more aspects of the present disclosure.

FIG. 3 shows an example of a process flow that supports interferer beam refinement for MU-MIMO communications in accordance with one or more aspects of the present disclosure.

FIGS. 4 and 5 show block diagrams of devices that support interferer beam refinement for MU-MIMO communications in accordance with one or more aspects of the present disclosure.

FIG. 6 shows a block diagram of a communications manager that supports interferer beam refinement for MU-MIMO communications in accordance with one or more aspects of the present disclosure.

FIG. 7 shows a diagram of a system including a device that supports interferer beam refinement for MU-MIMO communications in accordance with one or more aspects of the present disclosure.

FIGS. 8 and 9 show block diagrams of devices that support interferer beam refinement for MU-MIMO communications in accordance with one or more aspects of the present disclosure.

FIG. 10 shows a block diagram of a communications manager that supports interferer beam refinement for MU-MIMO communications in accordance with one or more aspects of the present disclosure.

FIG. 11 shows a diagram of a system including a device that supports interferer beam refinement for MU-MIMO communications in accordance with one or more aspects of the present disclosure.

FIGS. 12 and 13 show flowcharts illustrating methods that support interferer beam refinement for MU-MIMO communications in accordance with one or more aspects of the present disclosure.

### DETAILED DESCRIPTION

In some examples of wireless communications, one or more devices may operate in accordance with multi-user multiple-input, multiple-output (MU-MIMO) communications. For example, a network entity may concurrently transmit multiple data streams to a set of spatially multiplexed (SPMed) user equipments (UEs). In some examples, MU-MIMO communications may be based on one or more UEs updating a precoding matrix at the network entity using information of a channel from each network entity transmission antenna to each respective UE reception antenna. The network entity may receive the information for the channel based on periodically transmitting channel state information reference signals (CSI-RSs) or sounding reference signal (SRSs) and may receive feedback (e.g., precoding matrix information (PMI)) from each UE, sometimes simultaneously. In some examples, however, severe interference may result from simultaneous communications between the network entity and the multiple UEs, which may hinder communications of signaling used in preparing the precoding matrices. As such, the UEs may be unable to accurately prepare and utilize precoding matrices, which may result in inefficient communications and data loss.

The network entity and the set of UEs may increase communications reliability by communicating and refining the precoders utilized by each UE such that interference may be mitigated. For example, a network entity may transmit CSI-RS signaling to a first UE. The first UE may utilize the signaling to generate feedback (e.g., PMI, channel quality information (CQI)) and may transmit the feedback to the network entity, which may transmit the PMI or CQI of the first UE to a second UE. The network entity may also transmit PMI or CQI of the second UE to the first UE. The first UE may utilize the feedback of the second UE, as well as the generated feedback of the first UE, to refine a PMI of the second UE to mitigate interference at the first UE, and the second UE may do the same for the first UE. The UEs may transmit the modified PMIs (e.g., for the first UE, for the second UE) to the network entity, and the network entity may communicate with each of the UEs according to the updated PMIs modified by the other UE.

Aspects of the disclosure are initially described in the context of wireless communications systems. Aspects of the disclosure are also described in the context of process flows. Aspects of the disclosure are further illustrated by and described with reference to apparatus diagrams, system diagrams, and flowcharts that relate to interferer beam refinement for MU-MIMO communications.

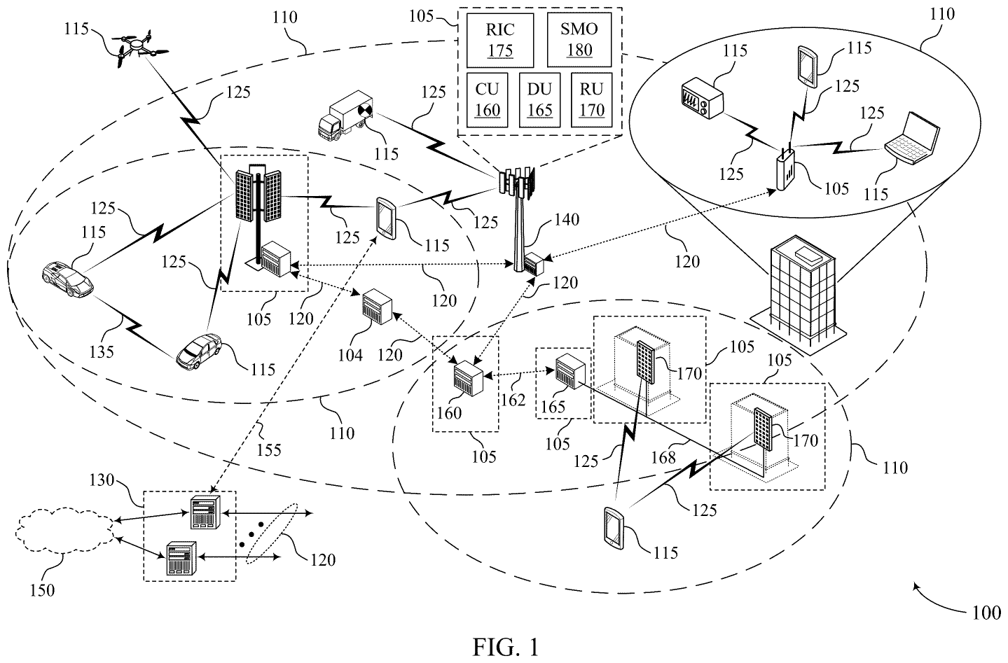

FIG. 1 shows an example of a wireless communications system 100 that supports interferer beam refinement for MU-MIMO communications in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and MU-MIMO, for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In the example of the wireless communications system 100, one or more devices may operate in accordance with MU-MIMO communications. For example, the network entity 105 may concurrently transmit multiple data streams to a set of SPMed UEs 115. In some examples, MU-MIMO communications may be based on the one or more UEs 115 updating a precoding matrix at the network entity 105 using information of a channel from each transmission antenna of the network entity 105 to each reception antenna of each respective UE 115. The network entity 105 may receive the information for the channel based on periodically transmitting CSI-RSs or SRSs and may receive feedback (e.g., PMI) from each UE 115, sometimes simultaneously. In some examples, however, severe interference may result from simultaneous communications between the network entity 105 and the UEs 115, which may hinder communications using the precoding matrices. As such, the UEs 115 may be unable to accurately prepare and utilize precoding matrices, which may result in inefficient communications and data loss.

The network entity 105 and the set of UEs 115 may increase communications reliability by communicating and refining the precoders utilized by each UE 115 such that interference may be mitigated. For example, a network entity 105 may transmit CSI-RS signaling to a first UE 115. The first UE 115 may utilize the signaling to generate feedback (e.g., PMI, CQI) and may transmit the feedback to the network entity 105, which may transmit the PMI or CQI of the first UE 115 to a second UE 115. The network entity 105 may also transmit PMI or CQI of the second UE 115 to the first UE 115. The first UE 115 may utilize the feedback of the second UE 115, as well as the generated feedback of the first UE 115, to refine a PMI of the second UE 115 to mitigate interference at the first UE 115, and the second UE 115 may do the same for the first UE 115. The UEs 115 may transmit the modified PMIs (e.g., for the first UE 115, for the second UE 115) to the network entity 105, and the network entity 105 may communicate with each of the UEs 115 according to the updated PMIs modified by the other UE 115.

Techniques of the present disclosure may increase reliability within the wireless communications system 100 by enabling a UE to refine the PMI associated with another UE. Techniques described herein may improve communications between the network entity 105 and the UEs 115 by increasing accuracy of or decreasing interference between associated transmission beams. As such, techniques described herein may enable more efficient utilization of communication resources, improved communication reliability, and improved coordination between devices.

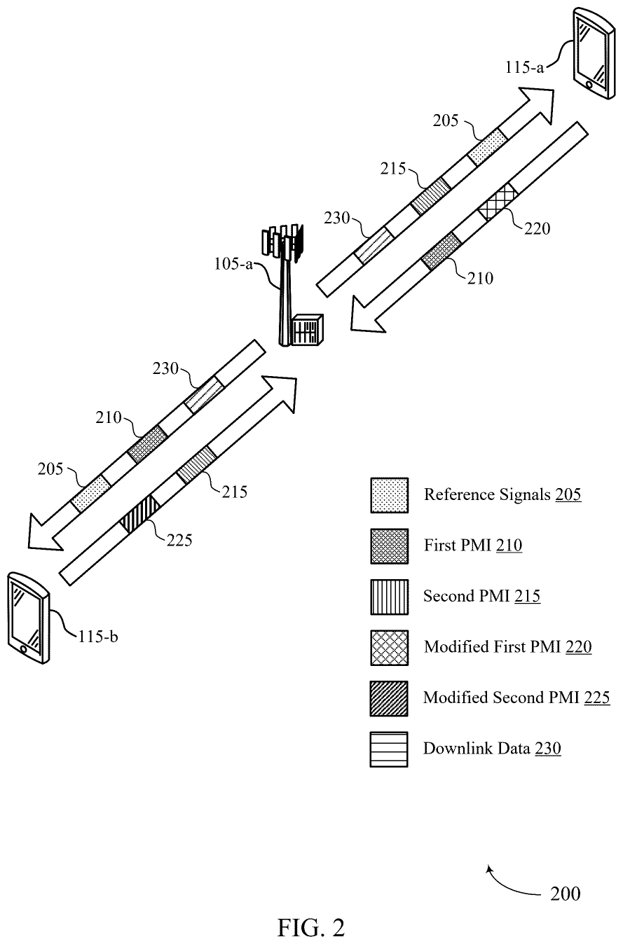

FIG. 2 shows an example of a wireless communications system 200 that supports interferer beam refinement for MU-MIMO communications in accordance with one or more aspects of the present disclosure. Aspects of the wireless communications system 200 may implement, or be implemented by, aspects of the wireless communications system 100. For example, the wireless communications system 200 illustrates signaling and various configurations that enable the refining of precoders associated with one or more UEs 115 to mitigate transmission interference.

In the example of the wireless communications system 200, one or more devices may operate in accordance with MU-MIMO communications. For example, the network entity 105-a may concurrently transmit multiple data streams to a set of SPMed UEs 115 (e.g., a UE 115-a, a UE 115-b). In some examples, the MU-MIMO communications may be based on the UEs 115 updating a precoding matrix at the network entity 105-a using information of a channel from each transmission antenna of the network entity 105-a to each reception antenna of each respective UE 115. The network entity 105-a may receive the information for the channel based on periodically transmitting CSI-RSs or SRSs and may receive feedback (e.g., PMI) from each UE 115, sometimes simultaneously. In some examples, however, severe interference may result from simultaneous communications between the network entity 105-a and the UEs 115, which may hinder communications using the precoding matrices. For example, the serving beams of the UE 115-a and the UE 115-b may overlap, which may cause interference and prevent effective communications between the UEs 115 and the network entity. As such, the UEs 115 may be unable to accurately prepare and utilize precoding matrices, which may result in inefficient communications or data loss.

The network entity 105-a and the set of UEs 115 may increase communications reliability by communicating and refining the precoders utilized by each UE 115 such that interference may be mitigated. For example, a network entity 105-a may transmit reference signals 205 (e.g., CSI-RS signaling) to the UE 115-a. The UE 115-a may utilize the signaling to generate PMI 210 or other feedback (e.g., CQI, interference levels, rank information) and may transmit the feedback to the network entity 105-a, which may transmit the PMI 210 (and optionally other feedback) from the UE 115-a to the UE 115-b. The network entity 105-a may also transmit reference signals 205 to the UE 115-b, which the UE 115-b may also utilize to generate PMI 215 and, optionally, other feedback. The UE 115-b may transmit the feedback to the network entity 105-a, which may transmit the PMI 215 (and optionally other feedback) from the UE 115-b to the UE 115-a. The PMI 210 and the PMI 215 may be associated with a best (e.g., most efficient) beam for communications with the network entity 105-a according to the respective UEs 115. In some examples, the network entity 105-a may transmit an explicit indication of the selected PMIs of each UE 115 to the other UE 115 (e.g., via control signaling), while in other examples the network entity 105-a may indicate the selected PMIs to each UE 115 via precoded CSI-RSs.

After receiving the respective PMI of the other (e.g., interfering) UE 115, each UE 115 may assist in adjusting the received PMIs (e.g., the PMI 210, the PMI 215) to mitigate interference from the serving beam of the other UE 115. For example, the UE 115-a may receive the PMI 215 of the UE 115-b from the network entity 105-a, and may utilize the PMI 215, as well as the feedback previously generated by the UE 115-a, to refine the PMI 215 of the UE 115-b. Similarly, the UE 115-b may receive the PMI 210 of the UE 115-a from the network entity 105-a, and may utilize the PMI 210, as well as the feedback previously generated by the UE 115-b, to refine the PMI 210 of the UE 115-a. In some examples, refining the PMIs of the UEs 115 may include each UE 115 computing an updated serving beam for the other UE 115 that may result in reduced communication interference. For example, the UE 115-a may utilize previously measured information (e.g., obtained from the reference signals 205) to update the PMI 215 of the UE 115-b to be associated with an updated (e.g., modified, adjusted) serving beam, which may result in lower communication interference between the UEs 115 and the network entity 105-a during communications. In some examples, each UE 115 may select modified PMIs for the other UE 115 such that the modified PMI may be similar to (e.g., near) the original PMI but including a small adjustment (e.g., perturbation, angle shift, amplitude adjustment). For example, the UE 115-b may know that p₀=PMIo is a serving beam for the UE 115-a, and that p_{1/2/3}=PM_{1/2/3} may not be the serving beam but may be located along orthogonal directions. In this case, the UE 115-b may utilize p=p₀+a₁*p+a₂*p₂+a₃*p₃ with small amplitude for a_{1/2/3}, such that p will be in the vicinity of p₀. In some examples, the resulting interference level associated with the modified PMIs may be calculated by multiplying a modified PMI (e.g., the modified PMI 220, the modified PMI 225) by the channel matrix.

After updating the serving beam (e.g., associated PMI) of the other UE 115, each of the UEs 115 may transmit the modified PMIs to the network entity 105-a, which may utilize the modified PMIs for future communications. For example, the UE 115-a may transmit the modified PMI 220 for the UE 115-b to the network entity 105-a, and the UE 115-b may transmit the modified PMI 225 for the UE 115-a to the network entity 105-a. The network entity 105-a may receive the modified PMIs, and may utilize them to communicate with the UE 115-a and the UE 115-b, respectively. For example, the network entity 105-a may receive the modified PMIs and apply them to precoders associated with communications with the respective UEs 115. The network entity 105-a may utilize a precoder prepared with the modified PMI 225 to communicate downlink data 230 with the UE 115-a, and may utilize a precoder prepared with the modified PMI 220 to communicate downlink data 230 with the UE 115-b.

In some examples, the network entity 105-a may inform each of the UEs 115 of the respective updated PMIs, while in other cases the network entity 105-a may not. In some cases, the network entity 105-a and the UEs 115 may repeat the steps as described herein in a iterative manner until a further refined serving beam and associated PMI may be obtained. For example, to account for overhead allowance and quality of the modified PMIs, the UEs 115 may perform repetitive PMI modification and transmission for each other UE 115. The UEs 115 and the network entity 105-a may repeat the process until one or both of the PMIs do not change, change less than a threshold, or change according to one or more predetermined conditions (e.g., to a previously selected PMI). Once the refinement process is over, the network entity 105-a may indicate to the UEs 115 which of the PMIs should be utilized as a main beam. The UEs 115 may utilize the main beam as a “center” beam of a sub-codebook for null refinement.

Additionally, or alternatively, the network entity 105-a may determine other serving beams and associated PMIs to use (e.g., different PMIs than the received, modified PMIs). For example, rather than utilize the modified PMIs for the precoders associated with communications, the network entity 105-a may update the modified PMIs according to MU criteria such as zero-forcing, TxMMSE, or signal to leakage plus noise ratio (SLNR) factors, and may utilize the resulting PMIs for the precoders. The criteria for the serving beams may be mitigating leakage from beams directed towards UEs to the other UEs. For example, for updating a serving beam W2, the beam may be modified to W2′ (e.g., according to the adjusted PMIs) such that norm (H1*W2′) is less than norm (H1*W2), while norm (H2*W2′) is similar to norm (H2*W2), or vice versa for updating W1 to W1′.

In some examples, the network entity 105-a may transmit additional information regarding a size of a refinement circle associated with communications with the UEs 115, where the refinement circle may be defined by the amplitude of aᵢ (e.g., cap on norm of vector {aᵢ} used for adjustment of PMI p to obtain the modified PMI p₀, as described above). In some cases, the network entity 105-a may assume a linear array and DFT codebook, may determine a refined precoder for one of the UEs 115, and may find a SNR loss distribution and interference level distribution with nearby precoders. The network entity 105-a may select the precoder for each respective UE 115 such that the interference gain may be larger than the SNR loss.

The network entity 105-a may provide each of the UEs 115 with an updated PMI, along with some designated CSI-RS including this criteria for interference refinement. The UEs 115 may measure the CSI-RS to determine the various criteria and may select codebooks that minimize communication interference. Utilizing the criteria from the network entity 105-a may enable each of the UEs 115 to refine the serving beam of the other UE 115 and decrease interference, as further described herein.

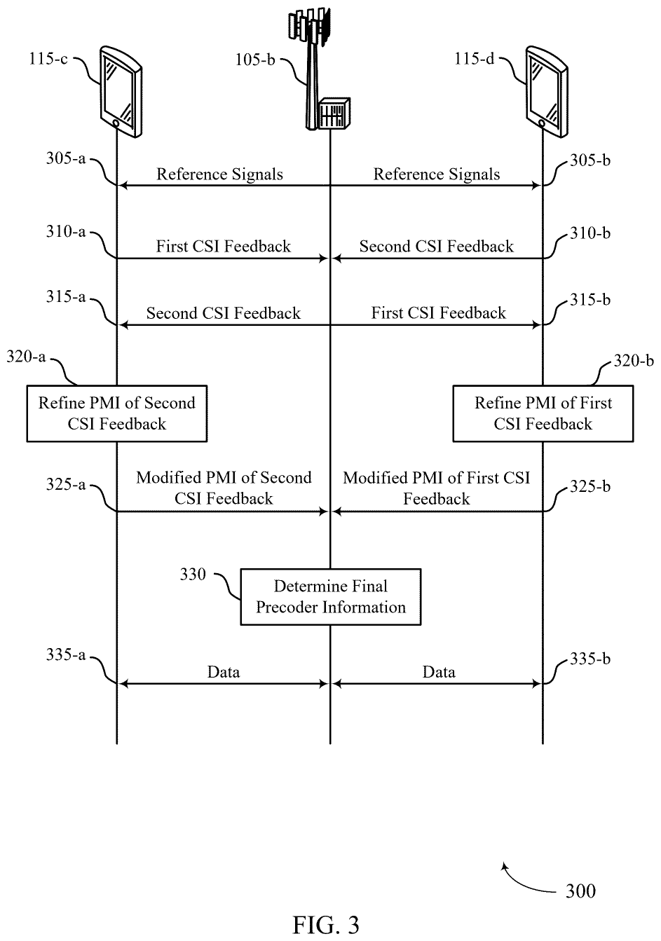

FIG. 3 shows an example of a process flow 300 that supports interferer beam refinement for MU-MIMO communications in accordance with one or more aspects of the present disclosure. Aspects of the process flow 300 may implement, or be implemented by, aspects of the wireless communications system 100 or the wireless communications system 200. For example, the process flow 300 illustrates signaling and various configurations that enable the refining of precoders associated with one or more UEs 115 to mitigate transmission interference.

The process flow 300 includes a UE 115-c, a UE 115-d and a network entity 105-b, which may be examples of UEs 115, network entities 105, and other wireless devices as described herein. For example, the UE 115-c, the UE 115-d, and the network entity 105-b illustrated in FIG. 3 may include examples of the UE 115-a, the UE 115-b, and the network entity 105-a, respectively, as illustrated in FIG. 2.

In some examples, the operations illustrated in process flow 300 may be performed by hardware (e.g., including circuitry, processing blocks, logic components, and other components), code such as processor-executable code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At 305, the network entity 105-b may transmit, and the UEs 115 may receive, one or more reference signals. For example, at 305-a, the network entity 105-b may transmit one or more reference signals to the UE 115-c and, at 305-b, the network entity may transmit one or more reference signals to the UE 115-d. The reference signals may be examples of CSI-RSs.

At 310, the UEs 115 may transmit, and the network entity 105-b may obtain, CSI feedback. For example, at 310-a, the UE 115-c may perform one or more measurements on the received reference signals to obtain first CSI feedback associated with a beam associated with the UE 115-c. The UE 115-c may transmit the first CSI feedback to the network entity 105-b. At 310-b, the UE 115-d may perform one or more measurements on the received reference signals to obtain second CSI feedback associated with a second beam associated with the UE 115-d. The UE 115-d may transmit the second CSI feedback to the network entity 105-b. The CSI feedback may include PMI, CQI, rank information, interference levels, or other information associated with precoding operations, for a respective beam associated with a MU-MIMO configuration.

At 315, the network entity 105-b may transmit, and the UEs 115 may receive, the CSI feedback from the other UE 115. The network entity may receive the feedback from a first UE 115 and forward it to a second UE 115. For example, at 315-a, the network entity 105-b may transmit (e.g., and the UE 115-c may receive) the second CSI feedback obtained from the UE 115-d. At 315-b, the network entity 105-b may transmit (e.g., and the UE 115-d may receive) the first CSI feedback obtained from the UE 115-c.

At 320, the UEs 115 may refine the PMI of the received CSI feedback associated with the other UE 115. For example, at 320-a, the UE 115-c may refine the second beam associated with the UE 115-d, and at 320-b the UE 115-d may refine the first beam associated with the UE 115-c. In some examples, refining each of beams may include determining one or more interference factors associated with the beam associated with the other UE 115, and adjusting the PMI information associated with the other UE 115 according to the interference factors, a predicted interference level of the beam associated with the other UE (e.g., and associated with the MU-MIMO configuration), measured CSI-RS, or a combination thereof. For example, the UE 115-c may determine one or more interference factors associated with the beam associated with the UE 115-d (e.g., interference between the first beam and the second beam), and may adjust the PMI of the UE 115-d forwarded by the network entity according to the measured interference factors. In some examples, refining the PMI of the other UE 115 may include a first UE 115 selecting a codebook for the other UE 115 according to the measured channel information, a predicted interference level of the beam associated with the other UE (e.g., and associated with the MU-MIMO configuration), measured CSI-RS, or a combination thereof.

At 325, the UEs 115 may transmit (e.g., and the network entity 105-b may receive) the modified PMI for the other UE 115 to the network entity 105-b. For example, in response to adjusting the PMIs (e.g., after selecting a codebook for the other UE 115), the UE 115-c may, at 325-a, transmit the refined PMI of the UE 115-d to the network entity 105-b, and the UE 115-d may, at 325-b, transmit the refined PMI of the UE 115-c to the network entity 105-b.

In some cases, the steps performed at 310, 315, 320, and 325 may be repeated one or more times. For example, the modified PMIs may be sent back to the UEs, and the UEs may estimate interference for the modified PMIs associated with the other UEs, which may further refine the modified PMIs for mitigating interference. In some cases, the steps performed at 310, 315, 320, and 325 may be repeated until the modified PMIs do not change, do not change more than a threshold, or result in a previously selected PMI, which may indicate that there is not an available adjustment of the PMI to further mitigate interference.

At 330, the network entity 105-b may determine one or more final PMIs for communicating with the UEs 115. For example, in response to receiving the adjusted PMIs from the UE 115-c and the UE 115-d, the network entity 105-b may determine to use the received, adjusted PMIs or may determine to use other PMIs (e.g., which may be based on the original or adjusted PMIs). For example, the network entity 105-b may determine to use PMIs other than the adjusted PMI received from the UEs 115. The network entity 105-b may transmit the PMIs to the UE 115-c and to the UE 115-d. In some examples, the network entity 105-b may transmit the PMIs to the UEs 115 via one or more DMRSs. The UEs 115 may receive the PMIs from the network entity 105-b, and may prepare to communicate using the PMIs.

At 335, the network entity 105-b may communicate data with the UEs 115 according to the final PMIs. For example, at 335-a the network entity 105-b may communicate with the UE 115-c according to the final PMI for the UE 115-c (e.g., adjusted PMI determined by the UE 115-d), and at 335-b the network entity 105-b may communicate with the UE 115-d according to the final PMI for the UE 115-d (e.g., adjusted PMI determined by the UE 115-c). In some examples, the network entity 105-b may communicate downlink data with the UEs 115 via layers of a MU-MIMO transmission. For example, the UE 115-c may receive downlink data from the network entity 105-b by receiving a first layer of the MU-MIMO transmission from the network entity 105-b, and the UE 115-d may receive downlink data from the network entity 105-b by receiving a second layer of the MU-MIMO transmission from the network entity 105-b.

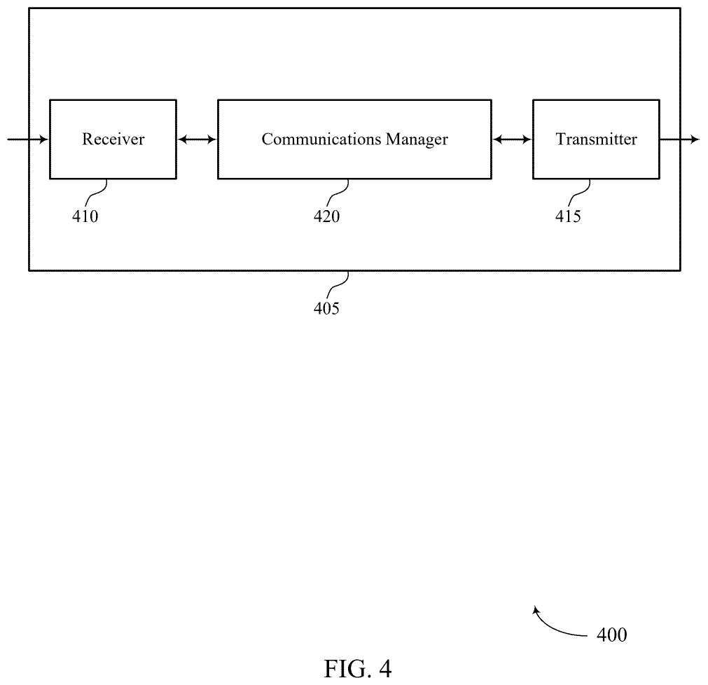

FIG. 4 shows a block diagram 400 of a device 405 that supports interferer beam refinement for MU-MIMO communications in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to interferer beam refinement for MU-MIMO in FDD). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to interferer beam refinement for MU-MIMO in FDD). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of interferer beam refinement for MU-MIMO communications as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for receiving, from a network entity, first precoding matrix information for a beam associated with a second UE for a MU-MIMO configuration. The communications manager 420 is capable of, configured to, or operable to support a means for transmitting, to the network entity, second precoding matrix information for an updated beam associated with the second UE, where the second precoding matrix information is based on measured channel information and a predicted interference level of the beam associated with the second UE and associated with the MU-MIMO configuration and the first precoding matrix information. The communications manager 420 is capable of, configured to, or operable to support a means for communicating with the network entity according to the MU-MIMO configuration based on transmitting the second precoding matrix information for the updated beam associated with the second UE.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for more efficient utilization of communication resources.

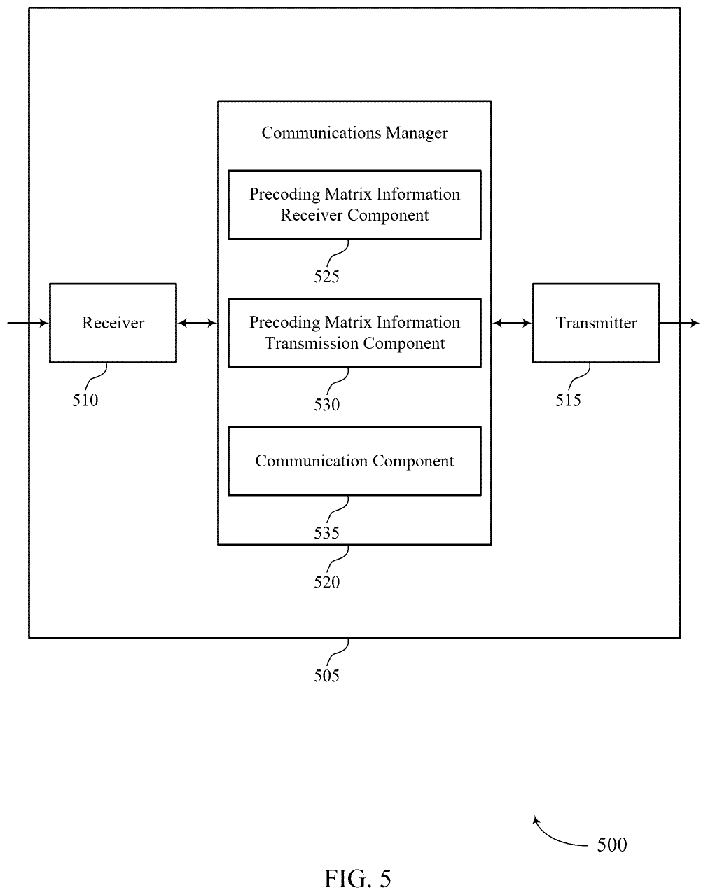

FIG. 5 shows a block diagram 500 of a device 505 that supports interferer beam refinement for MU-MIMO communications in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to interferer beam refinement for MU-MIMO communications). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to interferer beam refinement for MU-MIMO communications). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of interferer beam refinement for MU-MIMO communications as described herein. For example, the communications manager 520 may include a precoding matrix information receiver component 525, a precoding matrix information transmission component 530, a communication component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The precoding matrix information receiver component 525 is capable of, configured to, or operable to support a means for receiving, from a network entity, first precoding matrix information for a beam associated with a second UE for a MU-MIMO configuration. The precoding matrix information transmission component 530 is capable of, configured to, or operable to support a means for transmitting, to the network entity, second precoding matrix information for an updated beam associated with the second UE, where the second precoding matrix information is based on measured channel information and a predicted interference level of the beam associated with the second UE and associated with the MU-MIMO configuration and the first precoding matrix information. The communication component 535 is capable of, configured to, or operable to support a means for communicating with the network entity according to the MU-MIMO configuration based on transmitting the second precoding matrix information for the updated beam associated with the second UE.

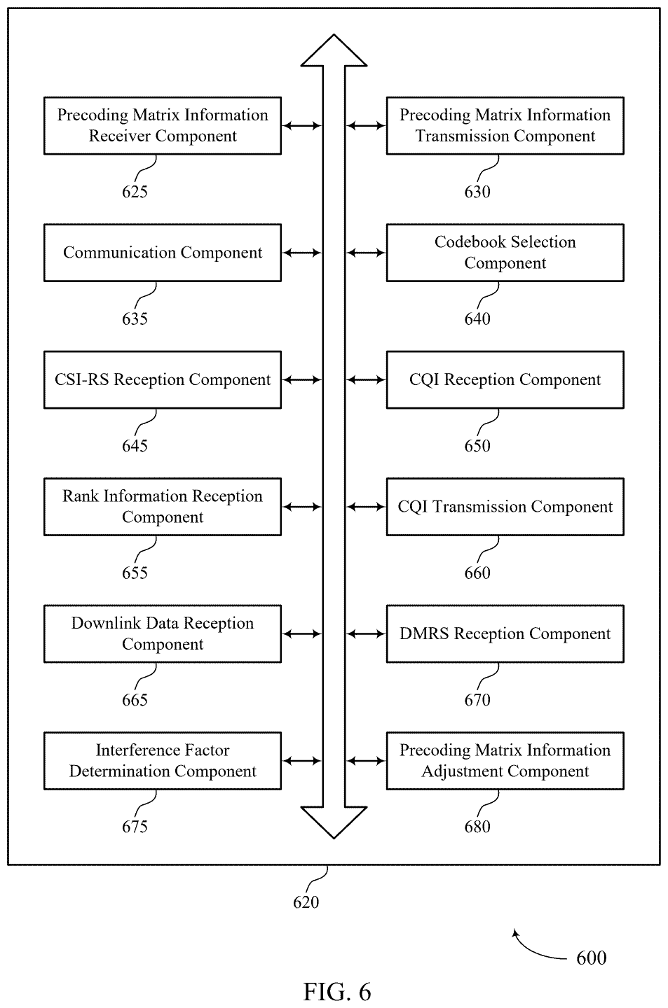

FIG. 6 shows a block diagram 600 of a communications manager 620 that supports interferer beam refinement for MU-MIMO communications in accordance with one or more aspects of the present disclosure. The communications manager 620 may be an example of aspects of a communications manager 420, a communications manager 520, or both, as described herein. The communications manager 620, or various components thereof, may be an example of means for performing various aspects of interferer beam refinement for MU-MIMO communications as described herein. For example, the communications manager 620 may include a precoding matrix information receiver component 625, a precoding matrix information transmission component 630, a communication component 635, a codebook selection component 640, a CSI-RS reception component 645, a CQI reception component 650, a rank information reception component 655, a CQI transmission component 660, a downlink data reception component 665, a DMRS reception component 670, an interference factor determination component 675, a precoding matrix information adjustment component 680, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The precoding matrix information receiver component 625 is capable of, configured to, or operable to support a means for receiving, from a network entity, first precoding matrix information for a beam associated with a second UE for a MU-MIMO configuration. The precoding matrix information transmission component 630 is capable of, configured to, or operable to support a means for transmitting, to the network entity, second precoding matrix information for an updated beam associated with the second UE, where the second precoding matrix information is based on measured channel information and a predicted interference level of the beam associated with the second UE and associated with the MU-MIMO configuration and the first precoding matrix information. The communication component 635 is capable of, configured to, or operable to support a means for communicating with the network entity according to the MU-MIMO configuration based on transmitting the second precoding matrix information for the updated beam associated with the second UE.

In some examples, the precoding matrix information transmission component 630 is capable of, configured to, or operable to support a means for transmitting, to the network entity, third precoding matrix information for a beam associated with the first UE for the MU-MIMO configuration, where the third precoding matrix information is based on the measured channel information associated with the MU-MIMO configuration. In some examples, the precoding matrix information receiver component 625 is capable of, configured to, or operable to support a means for receiving, from the network entity, fourth precoding matrix information for an updated beam associated with the first UE, where the fourth precoding matrix information is based on second channel information associated with the MU-MIMO configuration and the third precoding matrix information.

In some examples, to support receiving the fourth precoding matrix information for the updated beam associated with the first UE, the DMRS reception component 670 is capable of, configured to, or operable to support a means for receiving, from the network entity, one or more demodulated reference signals (DMRSs) including the fourth precoding matrix information.

In some examples, the codebook selection component 640 is capable of, configured to, or operable to support a means for selecting a codebook for the second UE according to the measured channel information and the predicted interference level of the beam associated with the second UE and associated with the MU-MIMO configuration and the first precoding matrix information, where transmitting the second precoding matrix information for the beam associated with the second UE is based on selecting the codebook.

In some examples, the interference factor determination component 675 is capable of, configured to, or operable to support a means for determining one or more interference factors associated with the beam associated with the second UE. In some examples, the precoding matrix information adjustment component 680 is capable of, configured to, or operable to support a means for adjusting the first precoding matrix information based on the one or more interference factors, where the second precoding matrix information corresponds to the adjusted first precoding matrix information.

In some examples, the CSI-RS reception component 645 is capable of, configured to, or operable to support a means for receiving, from the network entity, one or more channel state information reference signals (CSI-RS), where the second precoding matrix information is based on measurements of the one or more CSI-RS.

In some examples, the precoding matrix information receiver component 625 is capable of, configured to, or operable to support a means for receiving, from the network entity based on transmitting the second precoding matrix information, fifth precoding matrix information for the beam associated with the second UE for the MU-MIMO configuration. In some examples, the precoding matrix information transmission component 630 is capable of, configured to, or operable to support a means for transmitting, to the network entity, sixth precoding matrix information for the beam associated with the second UE, where the sixth precoding matrix information is based on the measured channel information associated with the MU-MIMO configuration and the fifth precoding matrix information.

In some examples, the CQI reception component 650 is capable of, configured to, or operable to support a means for receiving, from the network entity, one or more channel quality indicators (CQIs) associated with the second UE for the MU-MIMO configuration, where transmitting the second precoding matrix information is based on receiving the one or more CQIs.

In some examples, the rank information reception component 655 is capable of, configured to, or operable to support a means for receiving, from the network entity, rank information associated with the second UE for the MU-MIMO configuration, where transmitting the second precoding matrix information is based on the rank information.

In some examples, the CQI transmission component 660 is capable of, configured to, or operable to support a means for transmitting, to the network entity, one or more channel quality indicators (CQIs) and an interference level associated with the first UE for the MU-MIMO configuration.

In some examples, to support communicating with the network entity according to the MU-MIMO configuration, the downlink data reception component 665 is capable of, configured to, or operable to support a means for receiving, from the network entity, a layer of a MU-MIMO transmission including downlink data.

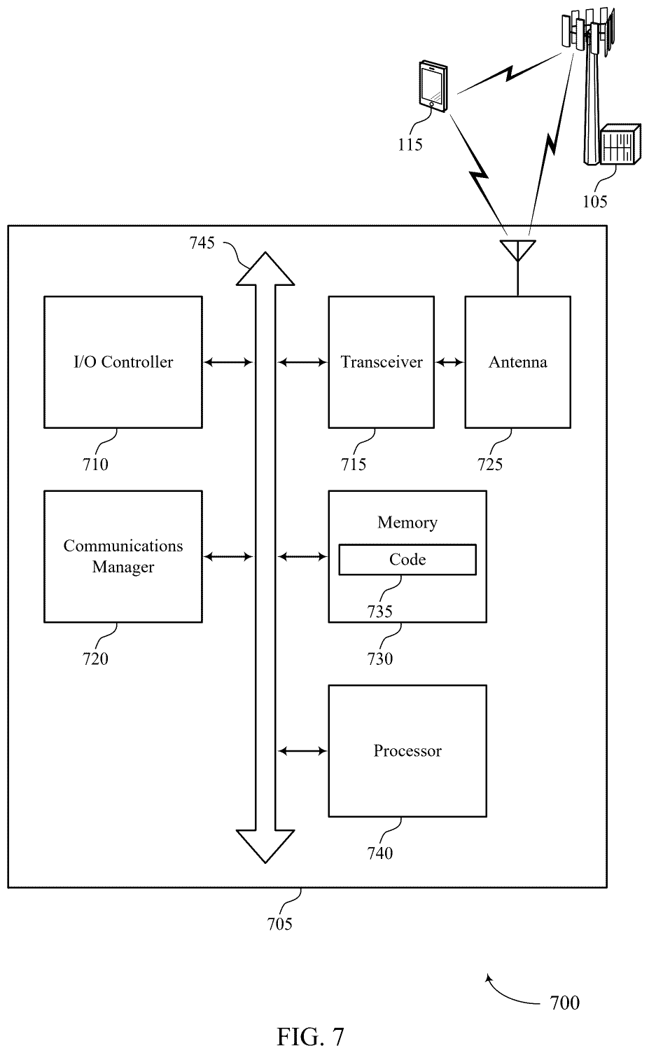

FIG. 7 shows a diagram of a system 700 including a device 705 that supports interferer beam refinement for MU-MIMO communications in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting interferer beam refinement for MU-MIMO communications). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for receiving, from a network entity, first precoding matrix information for a beam associated with a second UE for a MU-MIMO configuration. The communications manager 720 is capable of, configured to, or operable to support a means for transmitting, to the network entity, second precoding matrix information for an updated beam associated with the second UE, where the second precoding matrix information is based on measured channel information and a predicted interference level of the beam associated with the second UE and associated with the MU-MIMO configuration and the first precoding matrix information. The communications manager 720 is capable of, configured to, or operable to support a means for communicating with the network entity according to the MU-MIMO configuration based on transmitting the second precoding matrix information for the updated beam associated with the second UE.

By including or configuring the communications manager 720 in accordance with examples as described herein, the device 705 may support techniques for improved communication reliability, reduced latency, more efficient utilization of communication resources, and improved coordination between devices.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of interferer beam refinement for MU-MIMO communications as described herein, or the at least one processor 740 and the at least one memory 730 may be otherwise configured to, individually or collectively, perform or support such operations.

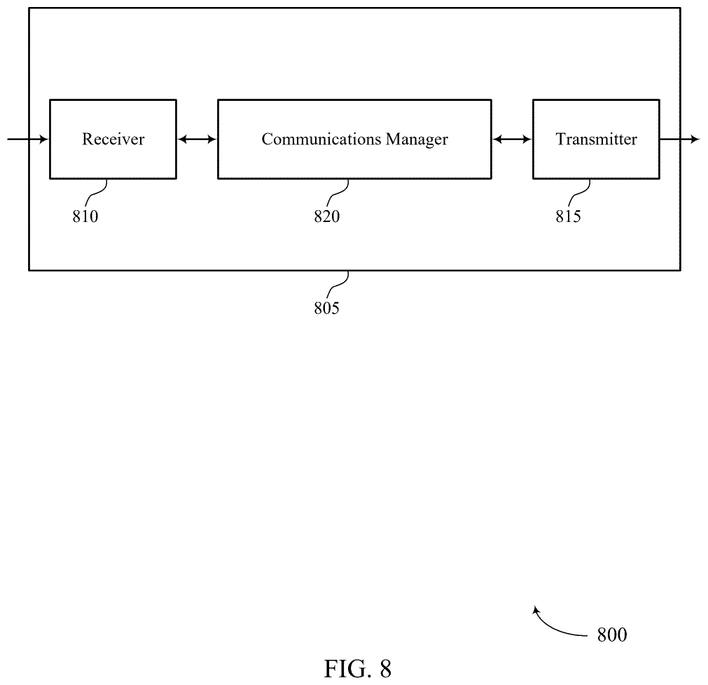

FIG. 8 shows a block diagram 800 of a device 805 that supports interferer beam refinement for MU-MIMO communications in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations or components thereof may be examples of means for performing various aspects of interferer beam refinement for MU-MIMO communications as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for outputting, to a first UE, first precoding matrix information for a beam associated with a second UE for a MU-MIMO configuration. The communications manager 820 is capable of, configured to, or operable to support a means for obtaining, from the first UE, second precoding matrix information for the beam associated with the second UE. The communications manager 820 is capable of, configured to, or operable to support a means for communicating with the first UE and the second UE according to the MU-MIMO configuration based on receiving the second precoding matrix information for the beam associated with the second UE.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for more efficient utilization of communication resources.

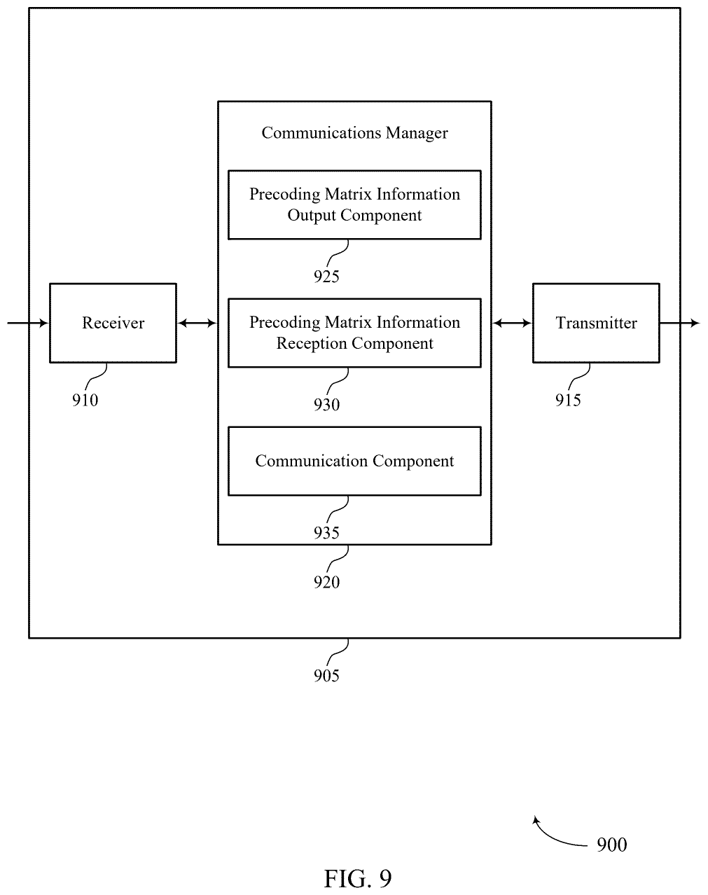

FIG. 9 shows a block diagram 900 of a device 905 that supports interferer beam refinement for MU-MIMO communications in accordance with one or more aspects of the present disclosure. The device 905 may be an example of aspects of a device 805 or a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of interferer beam refinement for MU-MIMO communications as described herein. For example, the communications manager 920 may include a precoding matrix information output component 925, a precoding matrix information reception component 930, a communication component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The precoding matrix information output component 925 is capable of, configured to, or operable to support a means for outputting, to a first UE, first precoding matrix information for a beam associated with a second UE for a MU-MIMO configuration. The precoding matrix information reception component 930 is capable of, configured to, or operable to support a means for obtaining, from the first UE, second precoding matrix information for the beam associated with the second UE. The communication component 935 is capable of, configured to, or operable to support a means for communicating with the first UE and the second UE according to the MU-MIMO configuration based on receiving the second precoding matrix information for the beam associated with the second UE.

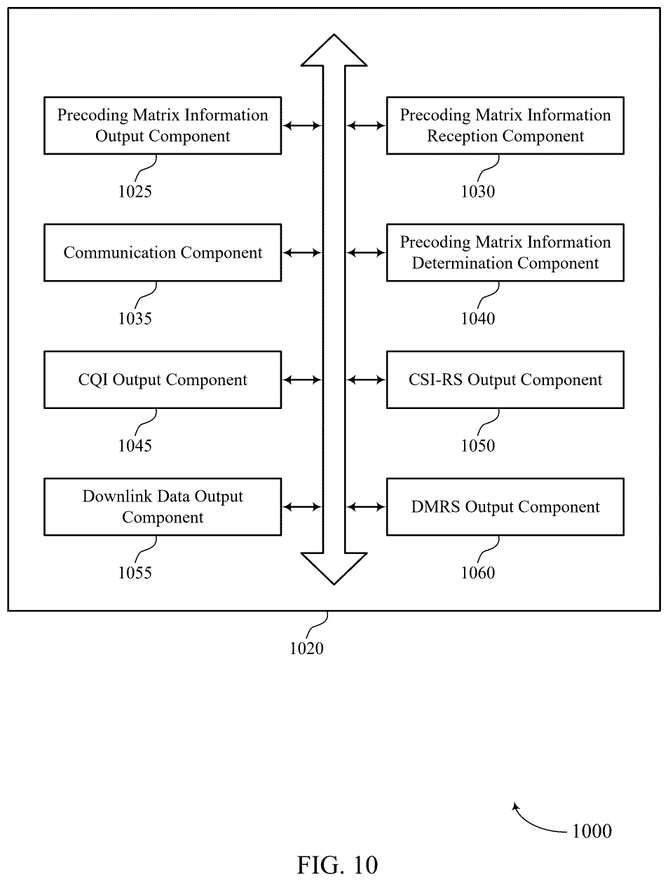

FIG. 10 shows a block diagram 1000 of a communications manager 1020 that supports interferer beam refinement for MU-MIMO communications in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of interferer beam refinement for MU-MIMO communications as described herein. For example, the communications manager 1020 may include a precoding matrix information output component 1025, a precoding matrix information reception component 1030, a communication component 1035, a precoding matrix information determination component 1040, a CQI output component 1045, a CSI-RS output component 1050, a downlink data output component 1055, a DMRS output component 1060, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications in accordance with examples as disclosed herein. The precoding matrix information output component 1025 is capable of, configured to, or operable to support a means for outputting, to a first UE, first precoding matrix information for a beam associated with a second UE for a MU-MIMO configuration. The precoding matrix information reception component 1030 is capable of, configured to, or operable to support a means for obtaining, from the first UE, second precoding matrix information for the beam associated with the second UE. The communication component 1035 is capable of, configured to, or operable to support a means for communicating with the first UE and the second UE according to the MU-MIMO configuration based on receiving the second precoding matrix information for the beam associated with the second UE.

In some examples, the precoding matrix information determination component 1040 is capable of, configured to, or operable to support a means for determining third precoding matrix information for the beam associated with the second UE based on receiving the second precoding matrix information, where communicating with the first UE according to the MU-MIMO configuration is based on the third precoding matrix information.

In some examples, the precoding matrix information output component 1025 is capable of, configured to, or operable to support a means for outputting, to the second UE, third precoding matrix information for a second beam associated with the first UE, where the third precoding matrix information is based on channel information associated with the MU-MIMO configuration measured by the first UE. In some examples, the precoding matrix information reception component 1030 is capable of, configured to, or operable to support a means for obtaining, from the second UE, fourth precoding matrix information for the second beam associated with the first UE. In some examples, the precoding matrix information output component 1025 is capable of, configured to, or operable to support a means for outputting, to the first UE, fifth precoding matrix information for the second beam associated with the first UE, where the fourth precoding matrix information is based on the fourth precoding matrix information.

In some examples, to support outputting the fifth precoding matrix information for the second beam associated with the first UE, the DMRS output component 1060 is capable of, configured to, or operable to support a means for outputting, to the first UE, one or more demodulated reference signals (DMRSs) including the fifth precoding matrix information.

In some examples, the CQI output component 1045 is capable of, configured to, or operable to support a means for outputting, to the first UE, one or more channel quality indicators (CQIs) associated with the second UE for the MU-MIMO configuration, where outputting the second precoding matrix information is based on obtaining the one or more CQIs.

In some examples, the CSI-RS output component 1050 is capable of, configured to, or operable to support a means for outputting, to the first UE, one or more channel state information reference signals (CSI-RS), where the one or more CSI-RS are determined based on the first precoding information.

In some examples, to support communicating with the first UE according to the MU-MIMO configuration, the downlink data output component 1055 is capable of, configured to, or operable to support a means for outputting, to the first UE, a first layer of a MU-MIMO transmission including first downlink data. In some examples, to support communicating with the first UE according to the MU-MIMO configuration, the downlink data output component 1055 is capable of, configured to, or operable to support a means for outputting, to the second UE concurrently with outputting the first layer, a second layer of the MU-MIMO transmission including second downlink data.

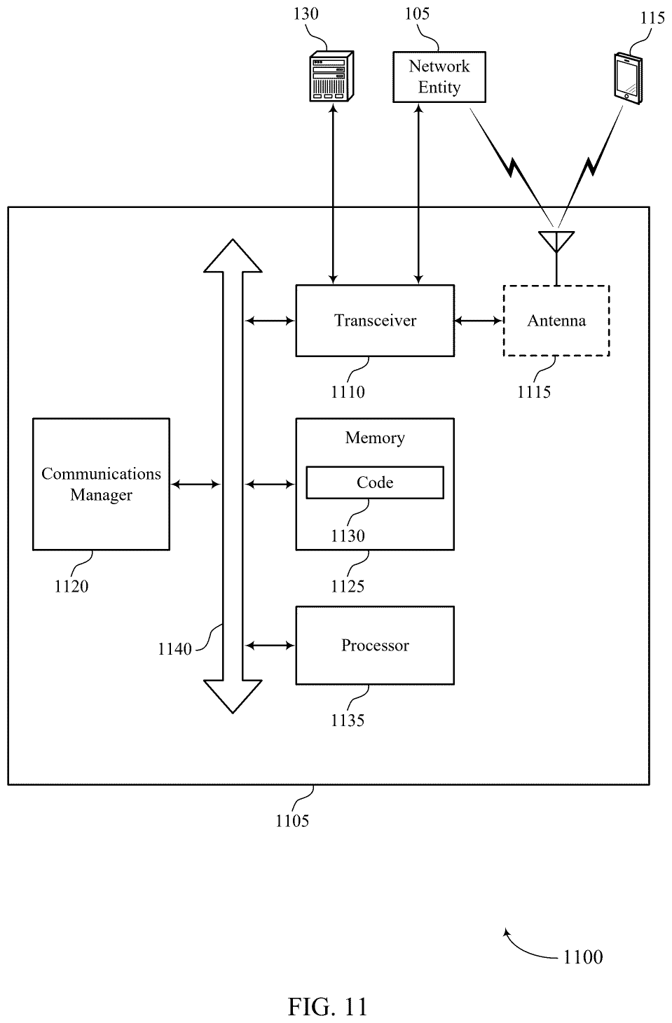

FIG. 11 shows a diagram of a system 1100 including a device 1105 that supports interferer beam refinement for MU-MIMO communications in accordance with one or more aspects of the present disclosure. The device 1105 may be an example of or include components of a device 805, a device 905, or a network entity 105 as described herein. The device 1105 may communicate with other network devices or network equipment such as one or more of the network entities 105, UEs 115, or any combination thereof. The communications may include communications over one or more wired interfaces, over one or more wireless interfaces, or any combination thereof. The device 1105 may include components that support outputting and obtaining communications, such as a communications manager 1120, a transceiver 1110, one or more antennas 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., communication link(s) 125, backhaul communication link(s) 120, a midhaul communication link 162, a fronthaul communication link 168).

The at least one memory 1125 may include RAM, ROM, or any combination thereof. The at least one memory 1125 may store computer-readable, computer-executable, or processor-executable code, such as the code 1130. The code 1130 may include instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may include, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting interferer beam refinement for MU-MIMO communications). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125).

In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. For example, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with one or more other network entities 105, and may include a controller or scheduler for controlling communications with UEs 115 (e.g., in cooperation with the one or more other network devices). In some examples, the communications manager 1120 may support an X2 interface within an LTE/LTE-A wireless communications network technology to provide communication between network entities 105.

The communications manager 1120 may support wireless communications in accordance with examples as disclosed herein. For example, the communications manager 1120 is capable of, configured to, or operable to support a means for outputting, to a first UE, first precoding matrix information for a beam associated with a second UE for a MU-MIMO configuration. The communications manager 1120 is capable of, configured to, or operable to support a means for obtaining, from the first UE, second precoding matrix information for the beam associated with the second UE. The communications manager 1120 is capable of, configured to, or operable to support a means for communicating with the first UE and the second UE according to the MU-MIMO configuration based on receiving the second precoding matrix information for the beam associated with the second UE.

By including or configuring the communications manager 1120 in accordance with examples as described herein, the device 1105 may support techniques for improved communication reliability, reduced latency, more efficient utilization of communication resources, and improved coordination between devices.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of interferer beam refinement for MU-MIMO communications as described herein, or the at least one processor 1135 and the at least one memory 1125 may be otherwise configured to, individually or collectively, perform or support such operations.

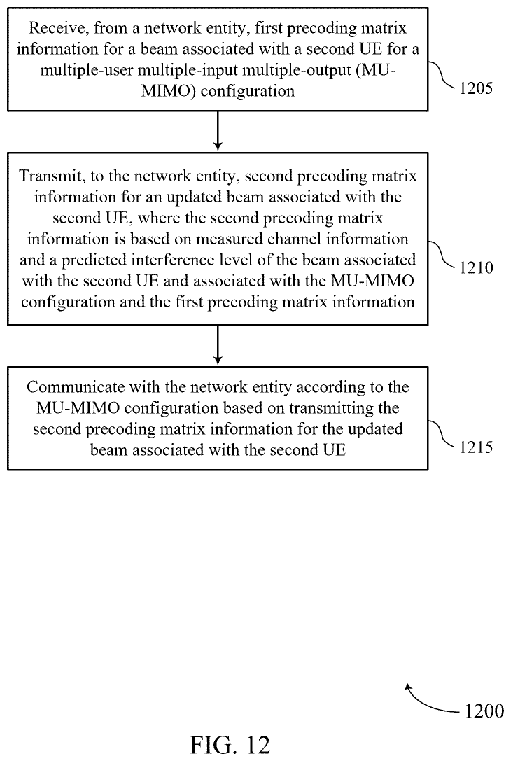

FIG. 12 shows a flowchart illustrating a method 1200 that supports interferer beam refinement for MU-MIMO communications in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include receiving, from a network entity, first precoding matrix information for a beam associated with a second UE for a MU-MIMO configuration. The operations of 1205 may be performed in accordance with examples as disclosed herein. In some examples, aspects of the operations of 1205 may be performed by a precoding matrix information receiver component 625 as described with reference to FIG. 6.

At 1210, the method may include transmitting, to the network entity, second precoding matrix information for an updated beam associated with the second UE, where the second precoding matrix information is based on measured channel information and a predicted interference level of the beam associated with the second UE and associated with the MU-MIMO configuration and the first precoding matrix information. The operations of 1210 may be performed in accordance with examples as disclosed herein. In some examples, aspects of the operations of 1210 may be performed by a precoding matrix information transmission component 630 as described with reference to FIG. 6.

At 1215, the method may include communicating with the network entity according to the MU-MIMO configuration based on transmitting the second precoding matrix information for the updated beam associated with the second UE. The operations of 1215 may be performed in accordance with examples as disclosed herein. In some examples, aspects of the operations of 1215 may be performed by a communication component 635 as described with reference to FIG. 6.

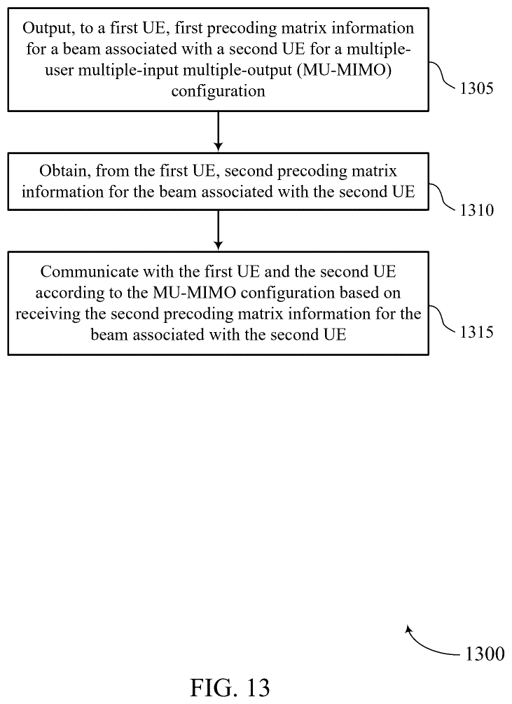

FIG. 13 shows a flowchart illustrating a method 1300 that supports interferer beam refinement for MU-MIMO communications in accordance with one or more aspects of the present disclosure. The operations of the method 1300 may be implemented by a network entity or its components as described herein. For example, the operations of the method 1300 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1305, the method may include outputting, to a first UE, first precoding matrix information for a beam associated with a second UE for a MU-MIMO configuration. The operations of 1305 may be performed in accordance with examples as disclosed herein. In some examples, aspects of the operations of 1305 may be performed by a precoding matrix information output component 1025 as described with reference to FIG. 10.

At 1310, the method may include obtaining, from the first UE, second precoding matrix information for the beam associated with the second UE. The operations of 1310 may be performed in accordance with examples as disclosed herein. In some examples, aspects of the operations of 1310 may be performed by a precoding matrix information reception component 1030 as described with reference to FIG. 10.

At 1315, the method may include communicating with the first UE and the second UE according to the MU-MIMO configuration based on receiving the second precoding matrix information for the beam associated with the second UE. The operations of 1315 may be performed in accordance with examples as disclosed herein. In some examples, aspects of the operations of 1315 may be performed by a communication component 1035 as described with reference to FIG. 10.

The following provides an overview of aspects of the present disclosure:

Aspect 1: A method for wireless communications at a first UE, comprising: receiving, from a network entity, first precoding matrix information for a beam associated with a second UE for a multiple-user multiple-input multiple-output (MU-MIMO) configuration; transmitting, to the network entity, second precoding matrix information for an updated beam associated with the second UE, wherein the second precoding matrix information is based at least in part on measured channel information and a predicted interference level of the beam associated with the second UE and associated with the MU-MIMO configuration and the first precoding matrix information; and communicating with the network entity according to the MU-MIMO configuration based at least in part on transmitting the second precoding matrix information for the updated beam associated with the second UE.

Aspect 2: The method of aspect 1, further comprising: transmitting, to the network entity, third precoding matrix information for a beam associated with the first UE for the MU-MIMO configuration, wherein the third precoding matrix information is based at least in part on the measured channel information associated with the MU-MIMO configuration; and receiving, from the network entity, fourth precoding matrix information for an updated beam associated with the first UE, wherein the fourth precoding matrix information is based at least in part on second channel information associated with the MU-MIMO configuration and the third precoding matrix information.

Aspect 3: The method of aspect 2, wherein receiving the fourth precoding matrix information for the updated beam associated with the first UE comprises: receiving, from the network entity, one or more demodulated reference signals (DMRSs) comprising the fourth precoding matrix information.

Aspect 4: The method of any of aspects 1 through 3, further comprising: selecting a codebook for the second UE according to the measured channel information and the predicted interference level of the beam associated with the second UE and associated with the MU-MIMO configuration and the first precoding matrix information, wherein transmitting the second precoding matrix information for the beam associated with the second UE is based at least in part on selecting the codebook.

Aspect 5: The method of aspect 4, further comprising: determining one or more interference factors associated with the beam associated with the second UE; and adjusting the first precoding matrix information based at least in part on the one or more interference factors, wherein the second precoding matrix information corresponds to the adjusted first precoding matrix information.

Aspect 6: The method of any of aspects 1 through 5, further comprising: receiving, from the network entity, one or more channel state information reference signals (CSI-RS), wherein the second precoding matrix information is based at least in part on measurements of the one or more CSI-RS.

Aspect 7: The method of any of aspects 1 through 6, comprising: receiving, from the network entity based at least in part on transmitting the second precoding matrix information, fifth precoding matrix information for the beam associated with the second UE for the MU-MIMO configuration; and transmitting, to the network entity, sixth precoding matrix information for the beam associated with the second UE, wherein the sixth precoding matrix information is based at least in part on the measured channel information associated with the MU-MIMO configuration and the fifth precoding matrix information.

Aspect 8: The method of any of aspects 1 through 7, comprising: receiving, from the network entity, one or more channel quality indicators (CQIs) associated with the second UE for the MU-MIMO configuration, wherein transmitting the second precoding matrix information is based at least in part on receiving the one or more CQIs.

Aspect 9: The method of any of aspects 1 through 8, comprising: receiving, from the network entity, rank information associated with the second UE for the MU-MIMO configuration, wherein transmitting the second precoding matrix information is based at least in part on the rank information.

Aspect 10: The method of any of aspects 1 through 9, comprising: transmitting, to the network entity, one or more channel quality indicators (CQIs) and an interference level associated with the first UE for the MU-MIMO configuration.

Aspect 11: The method of any of aspects 1 through 10, wherein communicating with the network entity according to the MU-MIMO configuration comprises: receiving, from the network entity, a layer of a MU-MIMO transmission comprising downlink data.

Aspect 12: A method for wireless communications at a network entity, comprising: outputting, to a first UE, first precoding matrix information for a beam associated with a second UE for a multiple-user multiple-input multiple-output (MU-MIMO) configuration; obtaining, from the first UE, second precoding matrix information for the beam associated with the second UE; and communicating with the first UE and the second UE according to the MU-MIMO configuration based at least in part on receiving the second precoding matrix information for the beam associated with the second UE.

Aspect 13: The method of aspect 12, comprising: determining third precoding matrix information for the beam associated with the second UE based at least in part on receiving the second precoding matrix information, wherein communicating with the first UE according to the MU-MIMO configuration is based at least in part on the third precoding matrix information.

Aspect 14: The method of any of aspects 12 through 13, comprising: outputting, to the second UE, third precoding matrix information for a second beam associated with the first UE, wherein the third precoding matrix information is based at least in part on channel information associated with the MU-MIMO configuration measured by the first UE; obtaining, from the second UE, fourth precoding matrix information for the second beam associated with the first UE; and outputting, to the first UE, fifth precoding matrix information for the second beam associated with the first UE, wherein the fourth precoding matrix information is based at least in part on the fourth precoding matrix information.

Aspect 15: The method of aspect 14, wherein outputting the fifth precoding matrix information for the second beam associated with the first UE comprises: outputting, to the first UE, one or more demodulated reference signals (DMRSs) comprising the fifth precoding matrix information.

Aspect 16: The method of any of aspects 12 through 15, comprising: outputting, to the first UE, one or more channel quality indicators (CQIs) associated with the second UE for the MU-MIMO configuration, wherein outputting the second precoding matrix information is based at least in part on obtaining the one or more CQIs.

Aspect 17: The method of any of aspects 12 through 16, further comprising: outputting, to the first UE, one or more channel state information reference signals (CSI-RS), wherein the one or more CSI-RS are determined based at least in part on the first precoding information.

Aspect 18: The method of any of aspects 12 through 17, wherein communicating with the first UE according to the MU-MIMO configuration comprises: outputting, to the first UE, a first layer of a MU-MIMO transmission comprising first downlink data; and outputting, to the second UE concurrently with outputting the first layer, a second layer of the MU-MIMO transmission comprising second downlink data.

Aspect 19: A first UE for wireless communications, comprising one or more memories storing processor-executable code, and one or more processors coupled with the one or more memories and individually or collectively operable to execute the code to cause the first UE to perform a method of any of aspects 1 through 11.

Aspect 20: A first UE for wireless communications, comprising at least one means for performing a method of any of aspects 1 through 11.

Aspect 21: A non-transitory computer-readable medium storing code for wireless communications, the code comprising instructions executable by one or more processors to perform a method of any of aspects 1 through 11.

Aspect 22: A network entity for wireless communications, comprising one or more memories storing processor-executable code, and one or more processors coupled with the one or more memories and individually or collectively operable to execute the code to cause the network entity to perform a method of any of aspects 12 through 18.

Aspect 23: A network entity for wireless communications, comprising at least one means for performing a method of any of aspects 12 through 18.

Aspect 24: A non-transitory computer-readable medium storing code for wireless communications, the code comprising instructions executable by one or more processors to perform a method of any of aspects 12 through 18.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first user equipment (UE) for wireless communications, comprising:
processing circuitry associated with one or more memory devices and configured to cause the first UE to:
receive, from a network entity, first precoding matrix information for a beam associated with a second UE for a multi-user multiple-input multiple-output (MU-MIMO) configuration;
transmit, to the network entity, second precoding matrix information for an updated beam associated with the second UE, wherein the second precoding matrix information is based at least in part on measured channel information and a predicted interference level of the beam associated with the second UE and associated with the MU-MIMO configuration and the first precoding matrix information; and
communicate with the network entity according to the MU-MIMO configuration based at least in part on transmitting the second precoding matrix information for the updated beam associated with the second UE.

2. The first UE of claim 1, wherein the processing circuitry is further configured to cause the first UE to:
transmit, to the network entity, third precoding matrix information for a beam associated with the first UE for the MU-MIMO configuration, wherein the third precoding matrix information is based at least in part on the measured channel information associated with the MU-MIMO configuration; and
receive, from the network entity, fourth precoding matrix information for an updated beam associated with the first UE, wherein the fourth precoding matrix information is based at least in part on second channel information associated with the MU-MIMO configuration and the third precoding matrix information.

3. The first UE of claim 2, wherein receiving the fourth precoding matrix information for the updated beam associated with the first UE comprises the processing circuitry configured to cause the first UE to:
receive, from the network entity, one or more demodulated reference signals (DMRSs) comprising the fourth precoding matrix information.

4. The first UE of claim 1, wherein the processing circuitry is further configured to cause the first UE to:
select a codebook for the second UE according to the measured channel information and the predicted interference level of the beam associated with the second UE and associated with the MU-MIMO configuration and the first precoding matrix information, wherein transmitting the second precoding matrix information for the beam associated with the second UE is based at least in part on selecting the codebook.

5. The first UE of claim 4, wherein the processing circuitry is further configured to cause the first UE to:
determine one or more interference factors associated with the beam associated with the second UE; and
adjust the first precoding matrix information based at least in part on the one or more interference factors, wherein the second precoding matrix information corresponds to the adjusted first precoding matrix information.

6. The first UE of claim 1, wherein the processing circuitry is further configured to cause the first UE to:
receive, from the network entity, one or more channel state information reference signals (CSI-RS), wherein the second precoding matrix information is based at least in part on measurements of the one or more CSI-RS.

7. The first UE of claim 1, wherein the processing circuitry is further configured to cause the first UE to:
receive, from the network entity based at least in part on transmitting the second precoding matrix information, fifth precoding matrix information for the beam associated with the second UE for the MU-MIMO configuration; and
transmit, to the network entity, sixth precoding matrix information for the beam associated with the second UE, wherein the sixth precoding matrix information is based at least in part on the measured channel information associated with the MU-MIMO configuration and the fifth precoding matrix information.

8. The first UE of claim 1, wherein the processing circuitry is further configured to cause the first UE to:
receive, from the network entity, one or more channel quality indicators (CQIs) associated with the second UE for the MU-MIMO configuration, wherein transmitting the second precoding matrix information is based at least in part on receiving the one or more CQIs.

9. The first UE of claim 1, wherein the processing circuitry is further configured to cause the first UE to:
receive, from the network entity, rank information associated with the second UE for the MU-MIMO configuration, wherein transmitting the second precoding matrix information is based at least in part on the rank information.

10. The first UE of claim 1, wherein the processing circuitry is further configured to cause the first UE to:
transmit, to the network entity, one or more channel quality indicators (CQIs) and an interference level associated with the first UE for the MU-MIMO configuration.

11. The first UE of claim 1, wherein communicating with the network entity according to the MU-MIMO configuration comprises the processing circuitry configured to cause the first UE to:
receive, from the network entity, a layer of a MU-MIMO transmission comprising downlink data.

12. A method for wireless communications at a first user equipment (UE), comprising:
receiving, from a network entity, first precoding matrix information for a beam associated with a second UE for a multi-user multiple-input multiple-output (MU-MIMO) configuration;
transmitting, to the network entity, second precoding matrix information for an updated beam associated with the second UE, wherein the second precoding matrix information is based at least in part on measured channel information and a predicted interference level of the beam associated with the second UE and associated with the MU-MIMO configuration and the first precoding matrix information; and
communicating with the network entity according to the MU-MIMO configuration based at least in part on transmitting the second precoding matrix information for the updated beam associated with the second UE.

13. The method of claim 12, further comprising:
transmitting, to the network entity, third precoding matrix information for a beam associated with the first UE for the MU-MIMO configuration, wherein the third precoding matrix information is based at least in part on the measured channel information associated with the MU-MIMO configuration; and
receiving, from the network entity, fourth precoding matrix information for an updated beam associated with the first UE, wherein the fourth precoding matrix information is based at least in part on second channel information associated with the MU-MIMO configuration and the third precoding matrix information.

14. The method of claim 13, wherein receiving the fourth precoding matrix information for the updated beam associated with the first UE comprises:
receiving, from the network entity, one or more demodulated reference signals (DMRSs) comprising the fourth precoding matrix information.

15. The method of claim 12, further comprising:
selecting a codebook for the second UE according to the measured channel information and the predicted interference level of the beam associated with the second UE and associated with the MU-MIMO configuration and the first precoding matrix information, wherein transmitting the second precoding matrix information for the beam associated with the second UE is based at least in part on selecting the codebook.

16. The method of claim 15, further comprising:
determining one or more interference factors associated with the beam associated with the second UE; and
adjusting the first precoding matrix information based at least in part on the one or more interference factors, wherein the second precoding matrix information corresponds to the adjusted first precoding matrix information.

17. The method of claim 12, further comprising:
receiving, from the network entity, one or more channel state information reference signals (CSI-RS), wherein the second precoding matrix information is based at least in part on measurements of the one or more CSI-RS.

18. The method of claim 12, comprising:
receiving, from the network entity based at least in part on transmitting the second precoding matrix information, fifth precoding matrix information for the beam associated with the second UE for the MU-MIMO configuration; and
transmitting, to the network entity, sixth precoding matrix information for the beam associated with the second UE, wherein the sixth precoding matrix information is based at least in part on the measured channel information associated with the MU-MIMO configuration and the fifth precoding matrix information.

19. The method of claim 12, comprising:
receiving, from the network entity, one or more channel quality indicators (CQIs) associated with the second UE for the MU-MIMO configuration, wherein transmitting the second precoding matrix information is based at least in part on receiving the one or more CQIs.

20. A non-transitory computer-readable medium storing code for wireless communications, the code comprising instructions executable by one or more processors to:
receive, from a network entity, first precoding matrix information for a beam associated with a second UE for a multi-user multiple-input multiple-output (MU-MIMO) configuration;
transmit, to the network entity, second precoding matrix information for an updated beam associated with the second UE, wherein the second precoding matrix information is based at least in part on measured channel information and a predicted interference level of the beam associated with the second UE and associated with the MU-MIMO configuration and the first precoding matrix information; and
communicate with the network entity according to the MU-MIMO configuration based at least in part on transmitting the second precoding matrix information for the updated beam associated with the second UE.
